(19) United States
(12) Patent Application Publication
(10) Pub. No.: US 2003/0200666 A1
(43) Pub. Date: Oct. 30, 2003

(54) Replaceable tip center punch system

(76) Inventor: Kenneth P. Baker, Remer, MN (US)

Correspondence Address: Michael S. Neustel, Suite No. 4, 2534 South University Drive, Fargo, ND, 58103, US

(21) Appl. No.: 10/278,119

(22) Filed: Oct. 21, 2002

Related U.S. Application Data
(60) Provisional application No. 60/376,271, filed on Apr. 29, 2002.

(51) Int. Cl. B26F 1/00

(52) U.S. Cl. 30/366

(57) ABSTRACT

A replaceable tip center punch system for eliminating the need for sharpening a center punch. The replaceable tip center punch system includes a handle member having an engaging head, and a tip member threadably attached to the handle member opposite of the engaging head. A threaded nut is preferably threadably attached to a threaded portion of the tip member for tightening against a shaft member of the handle member. A protective washer comprised of a resilient material preferably surrounds the shaft member adjacent the engaging head for protecting the hand of a user.

### CROSS REFERENCE TO RELATED APPLICATIONS

I hereby claim benefit under Title 35, U.S. Code, Section 119(e) of U.S. provisional patent application Serial No. 60/376,271 filed Apr. 29, 2002. The 60/376,271 application is currently pending. The 60/376,271 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to center punches and more specifically it relates to a replaceable tip center punch system for eliminating the need for sharpening a center punch.

2. Description of the Related Art

Center punches have been in use for years for marking hardened surfaces and for providing for a starting point for drilling into metal. Conventional center punches are constructed of a high carbon heat treated steel or similar hardened metal. A conventional center punch typically has an elongate shaft handle, a pointed end and an engaging end. The user grasps the shaft handle with their hand and positions the pointed end upon the surface to be marked. The user then strikes the engaging end with a hammer or similar object which drives the pointed end into the surface making a mark.

The main problem with conventional center punches is that the pointed end becomes dulled over extended periods of usage resulting in costly replacement costs. A further problem with conventional center punches is that they require users to constantly sharpen the pointed end thereof which is time consuming and hazardous. Another problem with conventional center punches is that they do not adequately protect the user's hand during the striking of the engaging end.

While these devices may be suitable for the particular purpose to which they address, they are not as suitable for eliminating the need for sharpening a center punch. Conventional center punches are difficult to utilize for extended periods of time.

In these respects, the replaceable tip center punch system according to the present invention substantially departs from the conventional concepts and designs of the prior art, and in so doing provides an apparatus primarily developed for the purpose of eliminating the need for sharpening a center punch.

### BRIEF SUMMARY OF THE INVENTION

In view of the foregoing disadvantages inherent in the known types of center punches now present in the prior art, the present invention provides a new replaceable tip center punch system construction wherein the same can be utilized for eliminating the need for sharpening a center punch.

The general purpose of the present invention, which will be described subsequently in greater detail, is to provide a new replaceable tip center punch system that has many of the advantages of the center punches mentioned heretofore and many novel features that result in a new replaceable tip center punch system which is not anticipated, rendered obvious, suggested, or even implied by any of the prior art center punches, either alone or in any combination thereof.

To attain this, the present invention generally comprises a handle member having an engaging head, and a tip member threadably attached to the handle member opposite of the engaging head. A threaded nut is preferably threadably attached to a threaded portion of the tip member for tightening against a shaft member of the handle member. A protective washer comprised of a resilient material preferably surrounds the shaft member adjacent the engaging head for protecting the hand of a user.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a replaceable tip center punch system that will overcome the shortcomings of the prior art devices.

A second object is to provide a replaceable tip center punch system for eliminating the need for sharpening a center punch.

Another object is to provide a replaceable tip center punch system that does not require replacement of the entire center punch when dulled.

An additional object is to provide a replaceable tip center punch system that provides for efficient replacement of the pointed tip of a center punch.

A further object is to provide a replaceable tip center punch system that protects the user's hand from damage during the striking thereof.

Another object is to provide a replaceable tip center punch system that may be utilized as a conventional center punch.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side view of the present invention.

FIG. 2 is a front upper perspective view of the present invention.

FIG. 3 is an exploded upper perspective view of the present invention.

FIG. 4 is a cross sectional view taken along line 4-4 of FIG. 1.

FIG. 5 is a cross sectional view taken along line 5-5 of FIG. 3.

### DETAILED DESCRIPTION OF THE INVENTION

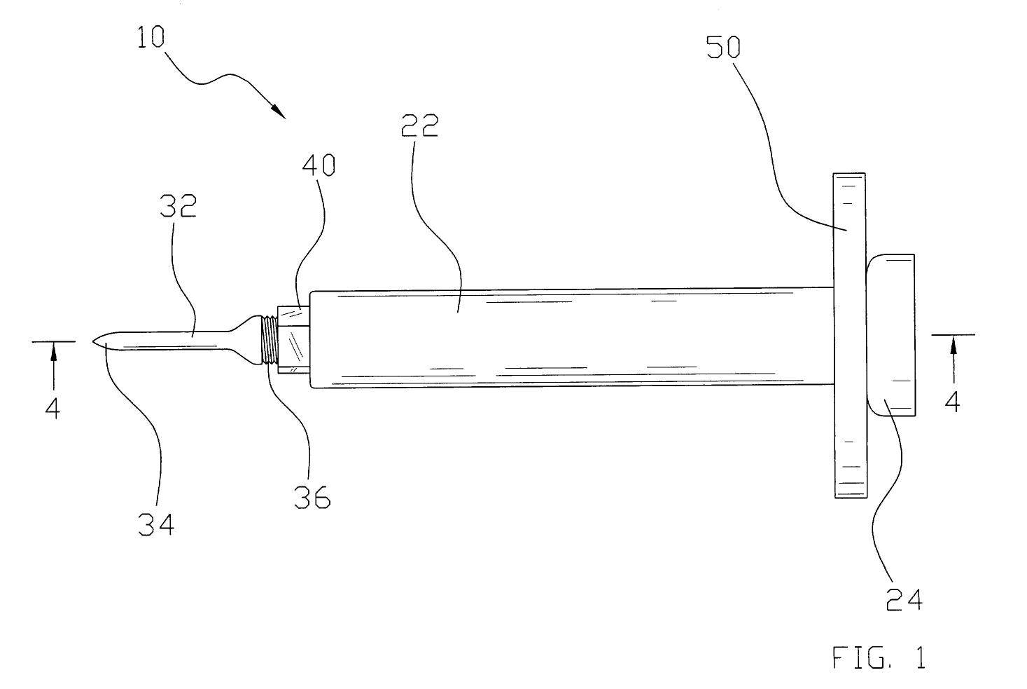

Turning now descriptively to the drawings, in which similar reference characters denote similar elements throughout the several views, FIGS. 1 through 5 illustrate a replaceable tip center punch system 10, which comprises a handle member 20 having an engaging head 24, and a tip member 30 threadably attached to the handle member 20 opposite of the engaging head 24. A threaded nut 40 is preferably threadably attached to a threaded portion 36 of the tip member 30 for tightening against a shaft member 22 of the handle member 20. A protective washer 50 comprised of a resilient material preferably surrounds the shaft member 22 adjacent the engaging head 24 for protecting the hand of a user.

As shown in FIGS. 1 through 3 of the drawings, the handle member 20 is comprised of an elongate structure. The handle member 20 is preferably between 4 to 8 inches in length, however the handle member 20 may have greater or less lengths. The handle member 20 preferably has a circularly cross sectional shape, however various other cross sectional shapes may be utilized. In addition, the diameter of the handle member 20 is preferably between ½ to 1 inch, however greater or less diameters may be utilized. The handle member 20 is preferably constructed of a rigid material such as but not limited to hardened steel.

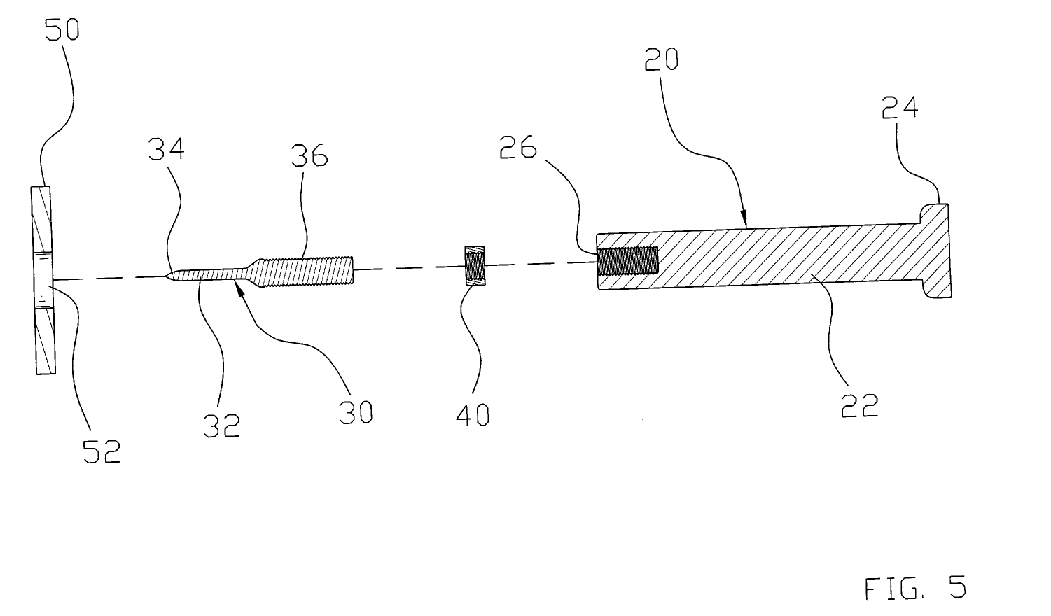

The handle member 20 has a shaft member 22, an engaging head 24 at one end of the shaft member 22 and a threaded aperture 26 within the shaft member 22 opposite of the engaging head 24. The engaging head 24 preferably has a greater diameter than the shaft member 22, however the engaging head 24 may be of equal or less size as the shaft member 22. The threaded aperture 26 extends concentrically within the shaft member 22 a finite distance as shown in FIG. 5 of the drawings.

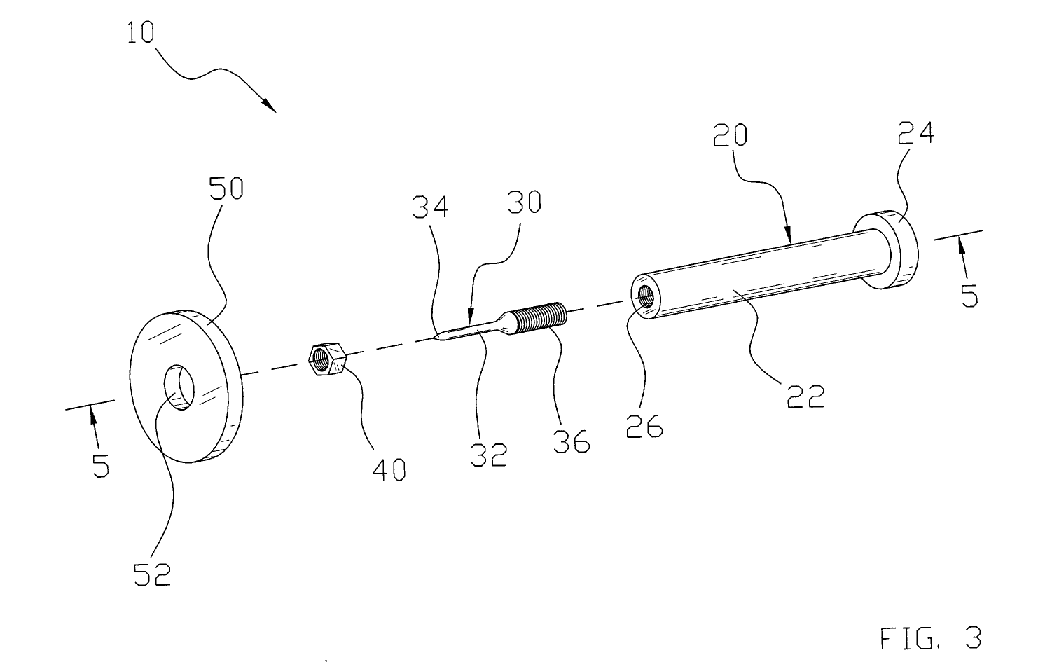

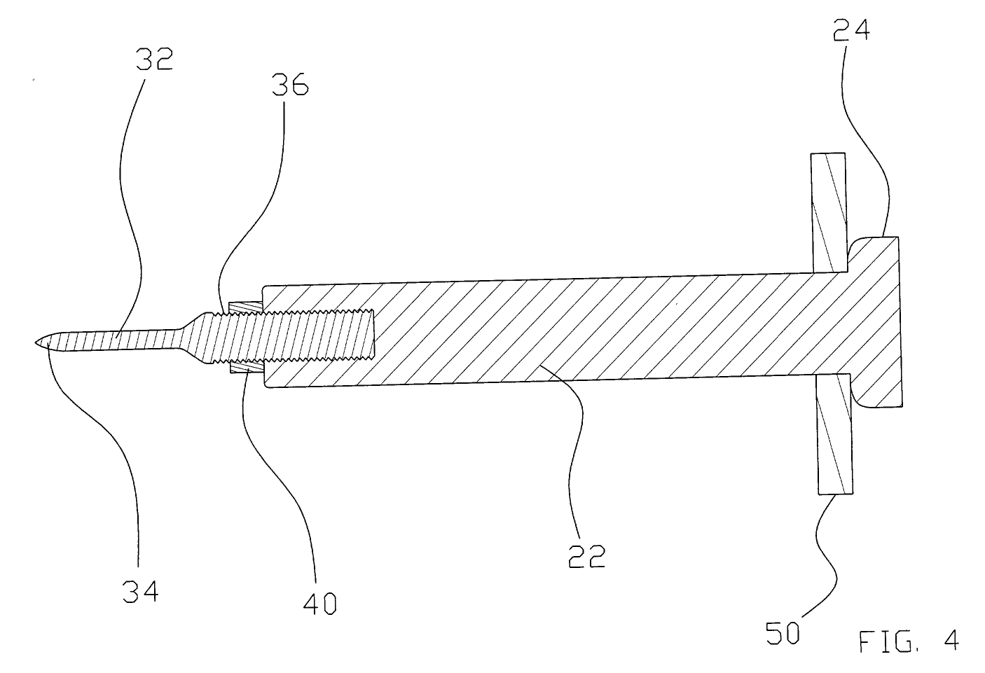

The tip member 30 is also comprised of a hardened elongate structure. The tip member 30 may be comprised of a hardened material such as but not limited to hardened steel. The tip member 30 has an elongate shaft 32 with a pointed end 34, and a threaded portion 36 opposite of the pointed end 34 as shown in FIGS. 3 and 5 of the drawings. The elongate shaft 32 may have a straight or tapered structure which are commonly utilized within the center punch industry. The threaded portion 36 is threaded for threadably securing within the threaded aperture 26 as best illustrated in FIG. 4 of the drawings.

The threaded portion 36 preferably has a length greater than the length of the threaded aperture 26 as shown in FIG. 4 of the drawings. The additional length of the threaded portion 36 allows for a portion of the threaded portion 36 to extend from the threaded aperture 26 of the shaft member 22.

As shown in FIGS. 1 through 5 of the drawings, a threaded nut 40 is provided that is threadably attached about the threaded portion 36 of the tip member 30. The threaded nut 40 is threadably positioned upon the threaded portion 36 and then secured against the shaft member 22 thereby retaining the tip member 30 in a tightened position within the shaft member 22 and preventing movement of the tip member 30.

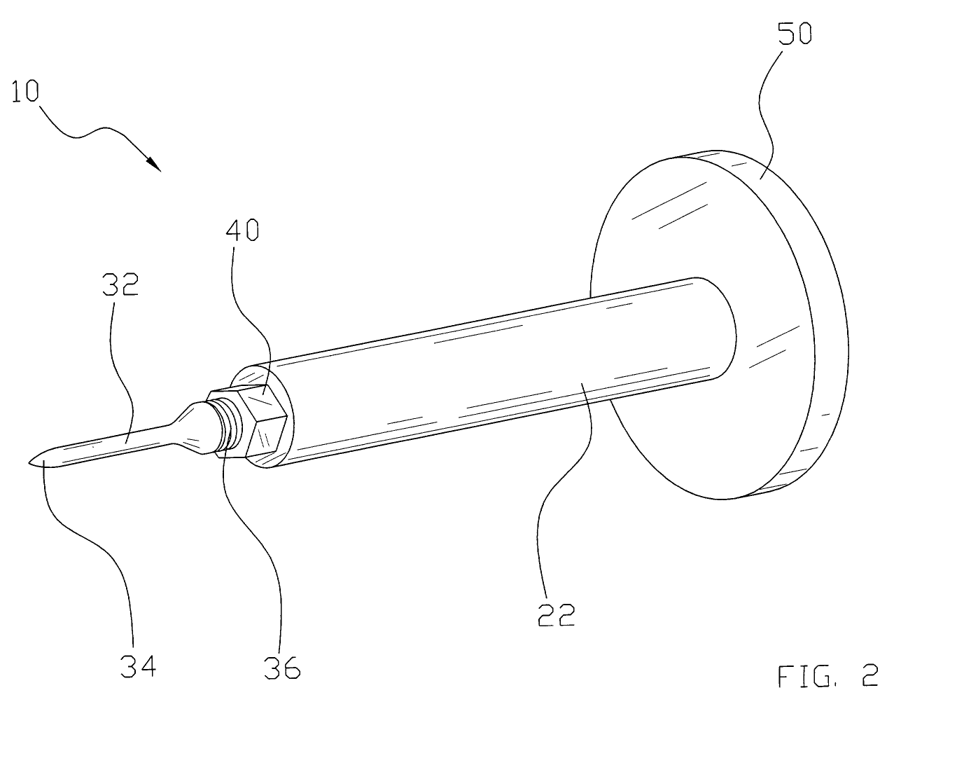

FIGS. 1 through 5 illustrate a protective washer 50 having a center aperture 52. The protective washer 50 is preferably comprised of a resilient material such as but not limited to leather, plastic, rubber and the like. The center aperture 52 of the protective washer 50 is preferably sized to snugly fit about the shaft member 22 of the handle member 20. The protective washer 50 is broader in size than the engaging head 24 as best illustrated in FIGS. 1 and 2 of the drawings. The protective washer 50 may have various thickness, sizes and shapes.

In use, the user utilizes the present invention as they would with a conventional center punch. The user grasps the shaft member 22 of the handle member 20 and then positions the pointed end 34 of the tip member 30 adjacent to the surface to be marked or punched. The user then engages the engaging head 24 with a hammer or similar object. If the hammer should miss or only partially engage the engaging head 24, the protective washer 50 protects the hand of the user grasping the shaft member 22 from becoming damaged. After an extended period of usage and the pointed end 34 becomes dulled, the user then loosens the threaded nut 40 and then threadably removes the tip member 30 from the handle member 20. The user then positions the threaded nut 40 upon a replacement tip member 30 and then threads the tip member 30 into the handle member 20. The threaded nut 40 is then tightened against the shaft member 22 after the threaded portion 36 is inserted into the threaded aperture 26 as desired as shown in FIG. 4 of the drawings.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A replaceable tip center punch system, comprising:
a handle member having a shaft member, an engaging head extending from a first end of said shaft member and a threaded aperture extending into a second end of said shaft member; and
a tip member having an elongated shaft with a pointed end and a threaded portion, wherein said threaded portion is threadably positioned within said threaded aperture.

2. The replaceable tip center punch system of claim 1, wherein said threaded portion has a length greater than a length of said threaded aperture.

3. The replaceable tip center punch system of claim 2, including a threaded nut threadably attached to said threaded portion for tightening against said handle member.

4. The replaceable tip center punch system of claim 1, including a threaded nut threadably attached to said threaded portion for tightening against said handle member.

5. The replaceable tip center punch system of claim 1, wherein said handle member and said tip member are comprised of a hardened metal.

6. The replaceable tip center punch system of claim 1, wherein said engaging head has a width greater than a width of said shaft member.

7. The replaceable tip center punch system of claim 1, including a protective washer having a center aperture positioned about said shaft member.

8. The replaceable tip center punch system of claim 7, wherein said threaded portion has a length greater than a length of said threaded aperture.

9. The replaceable tip center punch system of claim 8, including a threaded nut threadably attached to said threaded portion for tightening against said handle member.

10. The replaceable tip center punch system of claim 7, including a threaded nut threadably attached to said threaded portion for tightening against said handle member.

11. The replaceable tip center punch system of claim 7, wherein said handle member and said tip member are comprised of a hardened metal.

12. The replaceable tip center punch system of claim 7, wherein said engaging head has a width greater than a width of said shaft member.

13. A method of utilizing a replaceable tip center punch, said replaceable tip center punch comprising a handle member having a shaft member, an engaging head extending from a first end of said shaft member and a threaded aperture extending into a second end of said shaft member, a tip member having an elongated shaft with a pointed end and a threaded portion, wherein said threaded portion is threadably positioned within said threaded aperture, and a threaded nut threadably attached to said threaded portion for tightening against said handle member, said method comprising the steps of:
(a) loosening said threaded nut;
(b) rotating said tip member for threadably removing said tip member from said threaded aperture;
(c) providing a replacement tip member;
(d) threadably securing a threaded nut to said replacement tip member;
(e) threadably securing said replacement tip member within said threaded aperture; and
(f) securing said threaded nut against said shaft member.

14. The method of utilizing a replaceable tip center punch of claim 13, including the step of (g) positioning a protective washer upon said shaft member adjacent said engaging head.
